(19) United States
(12) Patent Application Publication
(10) Pub. No.: US 2024/0314714 A1
(43) Pub. Date: Sep. 19, 2024

(54) POSITIONING DEVICE AND METHOD FOR CORRECTING CLOCK

(71) Applicant: ALPS ALPINE CO., LTD., Tokyo (JP)

(72) Inventors: Yukimitsu YAMADA, Miyagi (JP); Daisuke TAKAI, Tokyo (JP)

(21) Appl. No.: 18/677,001

(22) Filed: May 29, 2024

Related U.S. Application Data
(63) Continuation of application No. PCT/JP2022/038185, filed on Oct. 13, 2022.

(30) Foreign Application Priority Data
Dec. 3, 2021 (JP) 2021-196786

(51) Int. Cl. H04W 56/00; G01S 5/02; H04W 64/00

(52) U.S. Cl. CPC H04W 56/005; G01S 5/0268; H04W 64/006

(57) ABSTRACT

A positioning device for determining a position of a mobile communication device includes a processor that corrects a clock of at least one of a first wireless communication device or a second wireless communication device that is disposed at a first distance from the first wireless communication device, based on a difference between the first distance and a second distance between the first wireless communication device and the second wireless communication device. The second distance is determined based on a first phase of a first signal transmitted at a first frequency from the first wireless communication device and is received by the second wireless communication device, a second phase of a second signal that is transmitted at a second frequency from the first wireless communication device and is received by the second wireless communication device, and the first distance.

### CROSS-REFERENCE TO RELATED APPLICATIONS

This application is a continuation application of International Application No. PCT/JP2022/038185, filed on Oct. 13, 2022, and designating the U.S., which is based upon and claims priority of Japanese Patent Application No. 2021-196786, filed on Dec. 3, 2021, the entire contents of which are incorporated herein by reference.

### BACKGROUND

### 1. Field of the Invention

The present disclosure relates to a positioning device and a method for correcting a clock.

### 2. Description of the Related Art

A conventional time synchronization system includes a parent device that supplies a synchronization signal to synchronize wireless base stations, and includes a child device that is connected to the parent device via a transmission path with a first channel and a second channel. The child device includes a global positioning system (GPS) receiver that receives a reference signal used in a GPS, a multiplexer that multiplexes reference signals on the first channel of the upstream signal to the parent device, and a transmitter that transmits the upstream signal via the transmission path. The parent device includes a multiplexer that multiplexes delay measurement signals on the second channel of a downstream signal to the child device, a transmitter that transmits the downstream signal via the transmission path, a separating unit that separates the first channel and the second channel from the upstream signal transmitted from the child device, a delay measurement unit that measures a delay time of the transmission path based on a delay measurement signal on the second channel, a first-phase correcting unit that corrects a phase of the reference signal on the first channel based on the delay time, and an output unit that outputs a first synchronization signal based on the reference signal that is corrected by the first-phase correcting unit (see Patent Document 1).

### RELATED-ART DOCUMENT

### Patent Document

[Patent Document 1] Japanese Unexamined Patent Application Publication No. 2012-004834

### SUMMARY

A positioning device for determining a position of a mobile communication device is provided. The positioning device includes a first wireless communication device, a second wireless communication device disposed at a first distance from the first wireless communication device, a processor configured to determine a second distance between the first wireless communication device and the second wireless communication device based on (i) a first phase of a first signal that is transmitted at a first frequency from the first wireless communication device and is received by the second wireless communication device, (ii) a second phase of a second signal that is transmitted at a second frequency from the first wireless communication device and is received by the second wireless communication device, and (iii) the first distance. The processor is configured to correct, based on a first differential distance between the first distance and the second distance, a clock of at least one of the first wireless communication device or the second wireless communication device, such that clocks of the first wireless communication device and the second wireless communication device are synchronized.

### BRIEF DESCRIPTION OF THE DRAWINGS

FIG. 1 is a diagram illustrates an example of a vehicle 10 with a positioning device according to an embodiment.

FIG. 2 is a block diagram illustrating a configuration example of a smartphone 200 and the vehicle 10 with the positioning device 100 according to the embodiment.

FIG. 3 is a diagram illustrating two hyperbolas defined using Equation (7).

FIG. 4 is a diagram illustrating the two hyperbolas defined using Equation (7) and coverage areas of wireless communication units 110A and 110B.

FIG. 5 is a diagram illustrating four hyperbolas determined in a third positioning method.

### DETAILED DESCRIPTION

The inventors of this application have recognized the following information in the related art. Global positioning system (GPS) signals are easily influenced by a communication environment or the like such as multipath that is caused by reflection, and as a result, a method for correcting a phase of a GPS reference signal by using a GPS signal has limited correction accuracy.

When positioning is performed using a time of arrival (TOA) in operations between wireless communication devices, in a case where a round trip time (RTT) is measured, a 1 ns (nanosecond)-level precision is required for phases of clocks of wireless communication devices.

In view of the situation recognized by the inventors, a positioning device and a method for correcting a clock that are capable of correcting one or more phases of clocks of wireless communication devices with high accuracy can be provided.

Hereinafter, various embodiments will be described using a positioning device and a method for correcting a clock.

### Embodiments

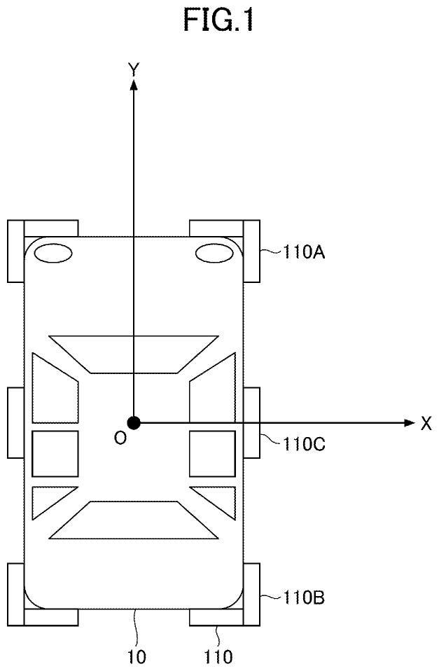

FIG. 1 is a diagram showing a vehicle 10 with a positioning device according to an embodiment. In FIG. 1, an XY coordinate system is defined in which a center of the vehicle 10 in a plan view is set as an origin 0. Multiple wireless communication units 110 are arranged at four corners of a body of the vehicle 10. The wireless communication unit 110 is an example of a wireless communication device. In the example of FIG. 1, ten wireless communication units 110 are illustrated. Among the given wireless communication units 110, a communication unit 110 is provided at each of the front left and right ends of the vehicle 10, and at each of the rear left and right ends of the vehicle 10. Also, among the given wireless communication units 110, a communication unit 110 is provided at each of the front left and rear left ends and at a middle portion of the vehicle 10, when viewed on a left side of the vehicle 10. In addition, among the given wireless communication units 110, a communication unit 110 is provided at each of the front left and rear left ends and at a middle portion of the vehicle 10, when viewed on a right side of the vehicle 10.

Any one of the ten wireless communication units 110 is an example of a first wireless communication unit, another one of the ten wireless communication units is an example of a second wireless communication unit, and yet another one of the ten wireless communication units is an example of a third wireless communication unit.

In this description, in an example, a given wireless communication unit 110 provided at a front right end of the vehicle 10 is expressed as a wireless communication unit 110A, a given wireless communication unit 110 provided at a rear right end of the vehicle 10 is expressed as a wireless communication unit 110B, and a given wireless communication unit 110 provided at a center right portion of the vehicle 10 in a longitudinal direction is expressed as a wireless communication unit 110C. The wireless communication unit 110A is an example of the first wireless communication unit, the wireless communication unit 110B is an example of the second wireless communication unit, and the wireless communication unit 110C is an example of the third wireless communication unit.

All clock frequencies that are used for the ten wireless communication units 110 to operate are the same. Each wireless communication unit 110 is a wireless communication unit that transmits or receives data with respect to a smartphone 200, and the wireless communication unit 110 is, for example, a short-range wireless communication device that applies Bluetooth (registered trademark) standards. Each wireless communication unit 110 has multiple antennas. The present embodiment is described using a case where the wireless communication unit 110 is a Bluetooth near-field communication device, but a device may perform communications through a wireless local area network (WLAN) or any other standard(s).

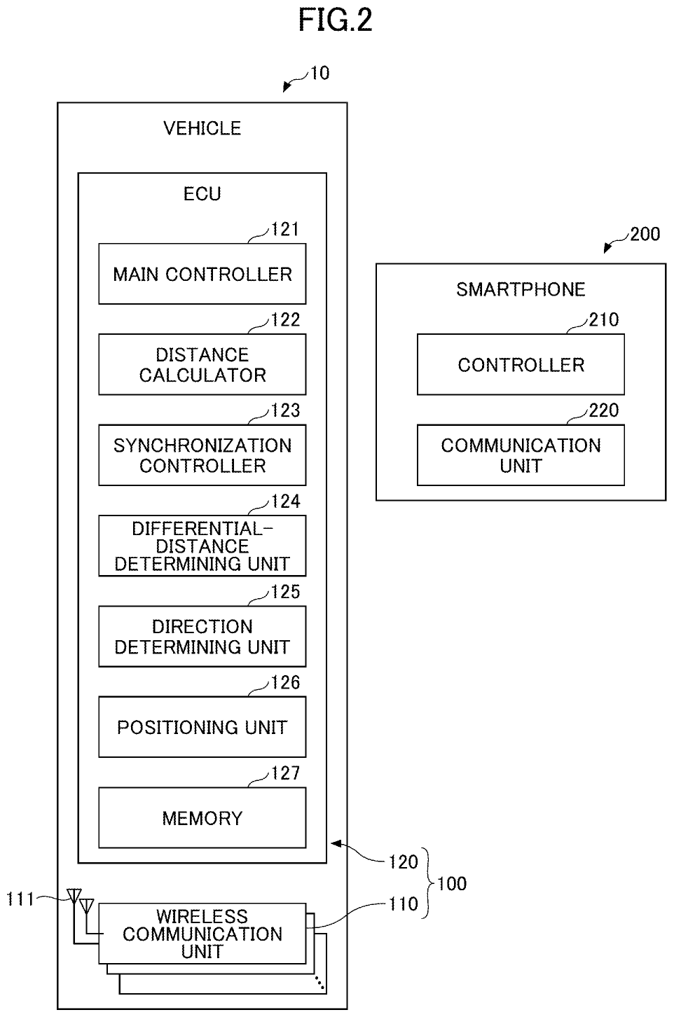

FIG. 2 is a block diagram showing a configuration example of the vehicle 10 and the smartphone 200, and the positioning device 100 according to the embodiment is mounted on the vehicle 10. The positioning device 100 includes the ten wireless communication units 110 and an electronic controller (ECU) 120, which are included in the vehicle 10. Each wireless communication unit 110 has multiple antennas 111. The number of antennas 111 that are connected to the wireless communication unit 110 may be 2 or more, for example, 3.

The smartphone 200 is an example of a mobile communication unit. When the smartphone 200 is outside the vehicle 10, a position of the smartphone 200 is determined (positioned) by the positioning device 100. The smartphone 200 includes a controller 210 and a communication unit 220. A user can use the smartphone 200 to operate a remote key, and as a result, the vehicle 10 can be unlocked or locked. Also, the user can operate an automatic parking support or the like through the smartphone 200.

The wireless communication unit 110 includes, for example, a power amplifier (PA), a low noise amplifier (LNA), an orthogonal modulator (OM), an orthogonal demodulator (ODM), a voltage controlled oscillator (VCO), a phase locked loop (PLL), and a codec processing unit, and the like. The PA is connected to the antennas 111. The wireless communication unit 110 is controlled by the ECU 120, and the wireless communication unit 110 uses Bluetooth packet signals to perform communications for ranging.

The ECU 120 is an ECU in the positioning device 100. In addition to including the ECU 120, the vehicle 10 is equipped with various ECUs, and is communicatively connected to the ECU 120 via an on-vehicle network.

The ECU 120 is implemented by a computer that includes a central processing unit (CPU), a random access memory (RAM), a read only memory (ROM), an internal bus, and the like. The ECU 120 includes a main controller 121, a distance calculator 122, a synchronization controller 123, a differential-distance determining unit 124, a direction determining unit 125, a positioning unit 126, and a memory 127. The main controller 121, the distance calculator 122, the synchronization controller 123, the differential-distance determining unit 124, the direction determining unit 125, and the positioning unit 126 are functions that are implemented by a program that the ECU 120 executes, and these units are expressed by function blocks. The memory 127 functionally expresses a memory of the ECU 120.

Hereinafter, first to fourth positioning methods that can be executed by the ECU 120 will be described. In each of the first to fourth positioning methods, the main controller 121 is a processing unit that supervises a control process by the ECU 120, and executes one or more processes other than processes that are executed by the distance calculator 122, the synchronization controller 123, the differential-distance determining unit 124, the direction determining unit 125, and the positioning unit 126.

The memory 127 stores one or more programs, data, and the like necessary for the main controller 121, the distance calculator 122, the synchronization controller 123, the differential—distance determining unit 124, the direction determining unit 125, and the positioning unit 126 to perform the above processes.

In each of the first to fourth positioning methods, the ECU 120 performs a synchronization process. The synchronization process is first described below, and next the first to fourth positioning methods will be described. In the description of the first and fourth positioning methods, the distance calculator 122, the synchronization controller 123, the differential—distance determining unit 124, the direction determining unit 125, and the positioning unit 126 will be described.

### Synchronization Process

The synchronization controller 123 performs the synchronization process based on a distance that is calculated by the distance calculator 122. In this process, one or more clocks of the wireless communication units 110A and 110B are corrected to be synchronized. In correcting the one or more clocks, a clock correction method is performed according to the embodiment. The clocks of the wireless communication units 110A and 110B are used for the wireless communication units 110A and 110B to operate. The wireless communication units 110A and 110B communicate with each other by using Bluetooth packet signals. In the synchronization process, any one among the antennas 111 that are connected to each wireless communication unit 110 may be used as a reference antenna 111.

The distance calculator 122 calculates a distance L between the wireless communication units 110A and 110B, based on (i) a phase of a packet signal that is transmitted at a frequency f1 from the wireless communication unit 110A and is received by the wireless communication unit 110B, (ii) a phase of a packet signal that is transmitted at a frequency f2 from the wireless communication unit 110A and is received by the wireless communication unit 110B, and (iii) a predetermined distance L0. Here, the frequency f1 is an example of a first frequency, and the frequency f2 is an example of a second frequency. The frequencies f1 and f2 relate to any two of multiple channels among channels that are included in a Bluetooth communication band, and for the frequencies f1 and f2, the same wavenumber is obtained in communications between the wireless communication units 110A and 110B. The predetermined distance L0 is an example of a first predetermined distance and is a distance between the wireless communication units 110A and 110B. The wireless communication units 110A and 110B are respectively attached to the front and rear ends of a side portion of the vehicle 10. In view of the above situation, the predetermined distance L0 is a known distance.

More specifically, the distance calculator 122 calculates the distance L between the wireless communication unit 110A and the wireless communication unit 110B, as described below. In calculating the distance L, the distance calculator 122 causes the wireless communication unit 110A to transmit a packet signal having the frequency f1 and a packet signal having the frequency f2. These packet signals having the frequencies f1 and f2 are received by the wireless communication unit 110B. Data indicating the predetermined distance L0 is stored in the memory 127.

The distance calculator 122 can determine

the distance L between the wireless communication units 110A and 110B, by use of Equations (1A) to (1E) below. Here, n expresses each of the wavenumber of the packet signal used at the frequency f1 between the wireless communication units 110A and 110B and the wavenumber of the packet signal used at the frequency f2 between the wireless communication units 110A and 110B. P1 expresses the phase of the packet signal having the frequency f1 that is received by the wireless communication unit 110B. P2 expresses the phase of the packet signal having the frequency f2 that is received by the wireless communication unit 110B. λ1 expresses a wavelength of the packet signal having the frequency f1, and λ2 expresses the wavelength of the packet signal having the frequency f2.

Specifically, with use of the wavenumber n, the phase P1, and the wavelength λ1 for the packet signal having the frequency f1, the distance L can be expressed by Equation (1).

$$\begin{matrix}[ Math . 1 ] & \\ L = ( n + P 1 ) \times λ1 & ( 1 )\end{matrix}$$

Similarly, with use of the wavenumber n, the phase P2, and the wavelength λ2 for the packet signal having the frequency f2, the distance L can be expressed by Equation (2).

$$\begin{matrix}[ Math . 2 ] & \\ L = ( n + P 2 ) \times λ2 & ( 2 )\end{matrix}$$

Equation (3) below is obtained from Equation (1).

$$\begin{matrix}[ Math . 3 ] & \\ n = L / λ1 - P 1 & ( 3 )\end{matrix}$$

Similarly, Equation (4) below is obtained from Equation (2).

$$\begin{matrix}[ Math . 4 ] & \\ n = L / λ2 - P 2 & ( 4 )\end{matrix}$$

When wavenumbers n are removed from Equations (3) and (4), and the resulting equation is transformed as illustrated below, the distance L can be expressed by Equation (5) below. Here, c is a speed of light (3×10⁸ m/sec).

$$\begin{matrix}[ Math . 5 ] & \\ L / λ1 - P 1 = L / λ2 - P 2 ( L / λ1 - L / λ2 ) = P 1 - P 2 L = P 1 - P 2 / ( 1 / λ1 - 1 / λ2 ) L = c \times ( P 1 - P 2 ) / ( f 1 - f 2 ) & ( 5 )\end{matrix}$$

The synchronization controller 123 corrects one or more among clocks of the wireless communication units 110A and 110B, based on a difference (L−L0) between the distance L calculated by the distance calculator 122 and the predetermined distance L0, such that the clocks are synchronized. If the clocks of the wireless communication units 110A and 110B are not matched, a given phase among the phases P1 and P2 is increased, and thus the difference (L−L0) between the distance L calculated by Equation (5) and the predetermined distance L0 as a known distance increases. The synchronization controller 123 may correct the phase for at least one of the wireless communication unit 110A or 110B based on the difference (L−L0), such that the clocks of the wireless communication units 110A and 110B are synchronized. The synchronization controller 123 may correct the phase of the clock with a 1 ns (nanosecond)-level precision. For example, when analysis is performed with respect to 360 degrees at 1 MHz with a resolution of 10 bits, a phase can be analyzed at a 1 ns-level and thus corrections can be made with a 1 ns-level precision.

Further, for example, under a condition in which (i) the relationship between the differential distance (L−L0) and correction amounts of phases for the wireless communication units 110A and 110B is determined in advance, and (ii) data having a table format is generated and is stored in the memory 127, a correction amount of a given phase corresponding to the differential distance (L−L0) may be read out to correct the given phase of the clock of at least one of the wireless communication unit 110A or 110B.

In the above example, a case where after the distance calculator 122 causes the wireless communication unit 110A to transmit packet signals at the frequencies f1 and f2, the wireless communication unit 110B receives the packet signals is described. However, unlike the case described above, a configuration in which after the distance calculator 122 causes the wireless communication unit 110B to transmit packet signals at the frequencies f1 and f2, the wireless communication unit 110A receives the packet signals can be adopted. In this case, one or more among phases of the clocks of the wireless communication units 110A and 110B can be corrected based on the packet signals transmitted from the wireless communication unit 110B. With this arrangement, in the synchronization process, packet signals are transmitted and received in bidirectional communications between the wireless communication units 110A and 110B, and thus one or more phases can be corrected more precisely such that phases of the clocks of the wireless communication units 110A and 110B are matched.

### First Positioning Method

After the synchronization controller 123 corrects one or more clocks, the differential-distance determining unit 124 determines a differential distance between the distance L1 from the smartphone 200 to the wireless communication unit 100 and the distance L2 from the smartphone 200 to the wireless communication unit 110B, based on (i) a phase α1 of the packet signal that is transmitted at the frequency f1 from the smartphone 200 and is received by the wireless communication unit 110A, (ii) a phase α2 of the packet signal that is transmitted at the frequency f2 from the smartphone 200 and is received by the wireless communication unit 110A, (iii) a phase α3 of the packet signal that is transmitted at the frequency f1 from the smartphone 200 and is received by the wireless communication unit 110B, and (iv) a phase α4 of the packet signal that is transmitted at the frequency f2 from the smartphone 200 and is received by the wireless communication unit 110B.

In the present embodiment, the packet signal transmitted at the frequency f1 from the smartphone 200 is an example of a first signal, and the phase α1 of the packet signal that the wireless communication unit 110A receives is an example of a first phase. The packet signal transmitted at the frequency f2 from the smartphone 200 is an example of a second signal, and the phase α2 of the packet signal that the wireless communication unit 110A receives is an example of a second phase. The phase α3 of the packet signal that is transmitted at the frequency f1 from the smartphone 200 that is received by the wireless communication unit 110B is an example of a third phase. The phase α4 of the packet signal that is transmitted at the frequency f2 from the smartphone 200 that is received by the wireless communication unit 110B is an example of a fourth phase. In the first positioning method, any one of the antennas 111 that are connected to each wireless communication unit 110 may be used as a reference antenna 111. The antennas 111 are used in the second positioning method described below, but when the positioning device 100 does not perform the second positioning method, each wireless communication unit 110 may have one antenna 111.

An absolute value |L1−L2| of the differential distance between the distance L1 and the distance L2 can be expressed by Equation (6) below.

$$\begin{matrix}[ Math . 6 ] & \\ \vert L 1 - L 2 \vert = \vert n + α 1 - β1 \vert = \vert n + α 2 - β2 \vert & ( 6 )\end{matrix}$$

The differential-distance determining unit 124 removes wavenumbers n from Equation (6), and then determines the absolute value |L1−L2| by using Equation (7) below. Here, c is a speed of light.

$$\begin{matrix}[ Math . 7 ] & \\ \vert L 1 - L 2 \vert = λ1λ2 ( α1 - β1 - ( α2 - β2 ) ) / ( λ1 - λ2 ) = c \times ( α1 - β1 - ( α2 - β2 ) ) / f 2 - f 1 & ( 7 )\end{matrix}$$

With this approach, when the differential—distance determining unit 124 determines the differential distance (|L1−L2|) between the distance L1 and the distance L2, the positioning unit 126 determines a position of the smartphone 200 with respect to the wireless communication units 110A and 110B, based on the differential distance (|L1−L2|) determined by the differential-distance determining unit 124.

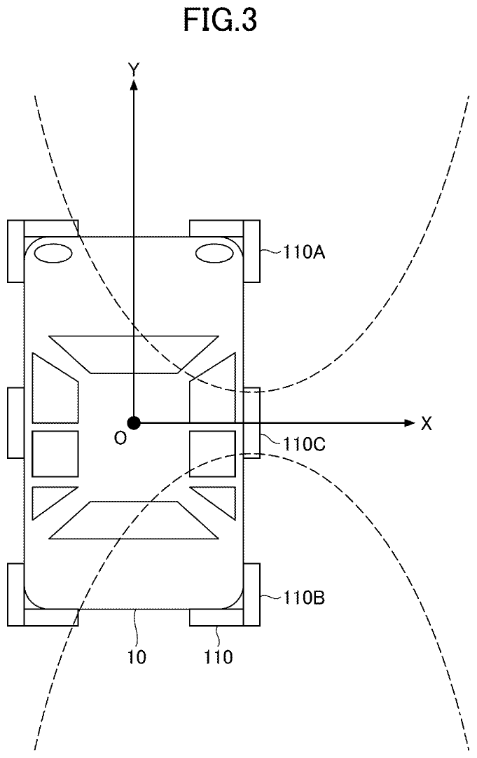

FIG. 3 is a diagram showing two hyperbolas defined using Equation (7). In FIG. 3, the two hyperbolas are expressed by dashed lines. The position of the smartphone 200 with respect to the wireless communication units 110A and 110B is at any portion on the two hyperbolas for which reference points for antennas 111 of the wireless communication units 110A and 110B are used as respective focal points. The positioning unit 126 can narrow the position of the smartphone 200 to positions on the two hyperbolas, and as a result, an approximate position of the smartphone 200 can be determined.

### Second Positioning Method

In a second positioning method, the differential—distance determining unit 124 determines the differential distance (|L1−L2|) that is expressed by Equation (7) in the first positioning method, then the direction determining unit 125 determines arrival directions in which packet signals from the smartphone 200 arrive at the respective wireless communication units 110A and 110B, and ultimately determines the position of the smartphone 200 with respect to the wireless communication units 110A and 110B, based on the two hyperbolas and the arrival directions.

The direction determining unit 125 determines the arrival direction in which the signal from the smartphone 200 arrives at the wireless communication unit 110A, based on a phase difference of the packet signal that is received by the antennas 111 of the wireless communication unit 110A. Further, the direction determining unit 125 determines the arrival direction in which the signal from the smartphone 200 arrives at the wireless communication unit 110B, based on the phase difference of the packet signal that is received by the antennas of the wireless communication unit 110B.

More specifically, the direction determining unit 125 determines the arrival direction in which the packet signal from the smartphone 200 arrives at the wireless communication unit 110A, based on the phase difference of the packet signal at the frequency f1 that is received by the antennas 111 of the wireless communication unit 110A. Here, the direction determining unit 125 may determine the arrival direction based on the phase difference of the packet signal at the frequency f2 that is received, or may determine two arrival directions based on a phase difference between two packet signals having frequencies f1 and f2 that are received. In this description, an example is described using a case where a given arrival direction is determined based on the phase difference of the packet signal at the frequency f1 that is received. The arrival direction in which the packet signal from the smartphone 200 arrives at the wireless communication unit 110A is an example of a first arrival direction.

The direction determining unit 125 also determines the arrival direction in which the packet signal from the smartphone 200 arrives at the wireless communication unit 110B, based on the phase difference of the packet signal at the frequency f1 that is received by the antennas 111 of the wireless communication unit 110B. Here, the direction determining unit 125 may determine the arrival direction based on the phase difference of the packet signal at the frequency f2 that is received, or may determine two arrival directions based on the phase difference between two packet signals having frequencies f1 and f2 that are received. In this description, an example is described using a case where a given arrival direction is determined based on the phase difference of the packet signal at the frequency f1 that is received. The arrival direction in which the packet signal from the smartphone 200 arrives at the wireless communication unit 110B is an example of a second arrival direction.

With this arrangement, when the direction determining unit 125 determines two arrival directions, the positioning unit 126 determines the position of the smartphone 200 with respect to the wireless communication units 110A and 110B, based on the differential distance determined by the differential-distance determining unit 124 and the two arrival directions determined by the direction determining unit 125.

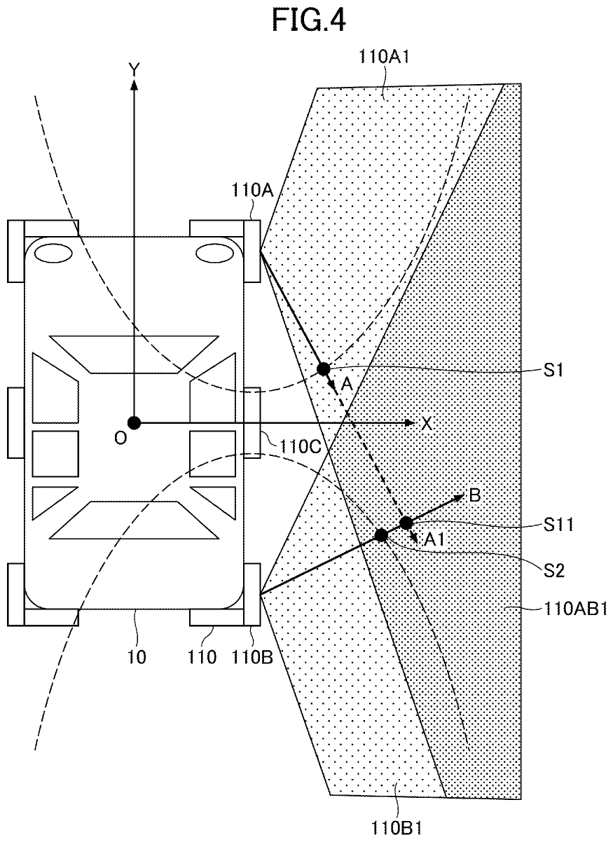

FIG. 4 is a diagram showing two hyperbolas defined using Equation (7) and coverage areas of the wireless communication units 110A and 110B. A coverage area 110A1 of the wireless communication unit 110A is an area in which the wireless communication unit 110A can receive packet signals from the smartphone 200 in a case where the smartphone 200 is in the coverage area 110A1. A coverage area 110B1 of the wireless communication unit 110B is an area in which the wireless communication unit 110B can receive packet signals from the smartphone 200 in a case where the smartphone 200 is in the coverage area 110B1. An overlap area 110AB1 is an overlap area between the coverage area 110A1 and the coverage area 110B1.

In FIG. 4, an arrow A expresses the arrival direction that is determined by the direction determining unit 125 and in which the packet signal arrives at the wireless communication unit 110A. An arrow B expresses the arrival direction that is determined by the direction determining unit 125 and in which the packet signal arrives at the wireless communication unit 110B.

The position of the smartphone 200 with respect to the wireless communication units 110A and 110B is at an intersection that is derived from a vector A expressed by the arrow A and a vector B expressed by the arrow B, and such a position of the smartphone 200 is determined as the intersection that is on any one of the hyperbolas. However, in reality, there are cases where the above intersection may not be determined due to an error or the like. In such a case, it is sufficient to take the following approach. The intersection is determined by prolonging the vector A or B, and subsequently, a position on a given hyperbola closest to the intersection may be determined as the position of the smartphone 200. In the example of FIG. 4, a vector A1 may be produced by prolonging the vector A, and a point S2 on the hyperbola that is closest to an intersection S11 between the vector A1 and the vector B may be set as the position of the smartphone 200. With this approach, the positioning unit 126 can identify the position of the smartphone 200 as a position of the intersection S2.

### Third Positioning Method

In a third positioning method, three wireless communication units 110A, 110B, and 110C are used to determine the position of the smartphone 200. In the third positioning method, the positioning device 100 does not determine an arrival direction by the direction determining unit 125 as described in the second positioning method. In other words, when the positioning device 100 executes the third positioning method instead of the second positioning method, the positioning device 100 may not include the direction determining unit 125.

Given the fact that the distance calculator 122 calculates a distance L between the wireless communication units 110A and 110B, and calculates a distance L between the wireless communication units 110A and 110C, the distance calculator 122 determines the distance L between the wireless communication units 110A and 110B as the same manner as described in the synchronization process described above.

The distance calculator 122 also determines a distance L between the wireless communication units 110A and 110C, based on (i) a phase of the packet signal that is transmitted at the frequency f1 from the wireless communication unit 110A and is received by the wireless communication unit 110C, (ii) a phase of the packet signal that is transmitted at the frequency f2 from the wireless communication unit 110A and is received by the wireless communication unit 110C, and (iii) a predetermined distance L00. The predetermined distance L00 is an example of a second predetermined distance that is known. The predetermined distance L00 is, for example, a distance between a reference point used for antennas 111 of the wireless communication unit 110A and a reference point used for antennas 111 of the wireless communication unit 110C. The distance L between the wireless communication units 110A and 110C is determined as in the distance L between the wireless communication units 110A and 110B.

As in the synchronization process described above, the synchronization controller 123 corrects one or more among clocks of the wireless communication units 110A and 110B such that the clocks are synchronized. In addition, the synchronization controller 123 corrects one or more among clocks of the wireless communication units 110A and 110C such that the clocks are synchronized, based on (i) a differential distance between the distance L from the wireless communication units 110A to the wireless communication unit 110C, determined by the distance calculator 122 and (ii) the predetermined distance L00.

After one or more among the clocks of the wireless communication units 110A, 110B, and 110C are corrected, the differential-distance determining unit 124 determines a differential distance between a distance from the smartphone 200 to the wireless communication unit 110A and a distance from the smartphone 200 to the wireless communication unit 110C, based on (i) a phase α5 of the packet signal that is transmitted at the frequency f1 from the smartphone 200 and is received by the wireless communication unit 110C, (ii) a phase α6 of the packet signal that is transmitted at the frequency f2 from the smartphone 200 and is received by the wireless communication unit 110C, and (iii) phases α1 and α2. The phase α5 is an example of a fifth phase, and the phase α6 is an example of a sixth phase.

The positioning unit 126 determines the position of the smartphone 200 with respect to the wireless communication units 110A, 110B, and 110C, based on (i) a differential distance between the distance from the smartphone 200 to the wireless communication unit 110A and the distance from the smartphone 200 to the wireless communication unit 110B, (ii) a differential distance between the distance from the smartphone 200 to the wireless communication unit 110A and the distance from the smartphone 200 to the wireless communication unit 110C. In this case, these differential distances are determined by the differential-distance determining unit 124.

In the third positioning method, the two hyperbolas shown in FIG. 3 are determined based on the differential distance between the distance from the smartphone 200 to the wireless communication unit 110A and the distance from the smartphone 200 to the wireless communication unit 110B. Similarly, two hyperbolas are further determined based on the differential distance between the distance from the smartphone 200 to the wireless communication unit 110A and the distance from the smartphone 200 to the wireless communication unit 110C. That is, in the third positioning method, four hyperbolas are determined.

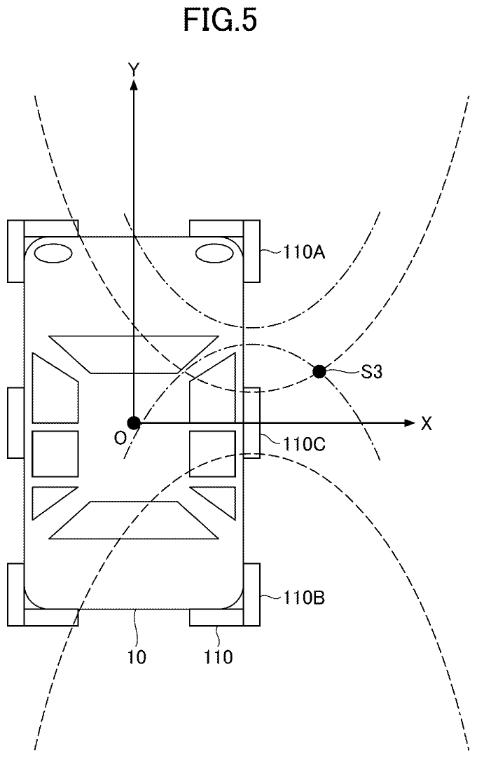

FIG. 5 is a diagram showing the four hyperbolas determined in the third positioning method. In FIG. 5, as in FIG. 3, dashed lines express two hyperbolas that are determined based on the differential distance between the distance from the smartphone 200 to the wireless communication unit 110A and the distance from the smartphone 200 to the wireless communication unit 110B. Dash-dot lines express two hyperbolas that are determined based on the differential distance between the distance from the smartphone 200 to the wireless communication unit 110A and the distance from the smartphone 200 and the wireless communication unit 110C.

The position of the smartphone 200 with respect to the wireless communication units 110A and 110B is at an intersection S3 outside the vehicle 10, among one or more intersections of the two hyperbolas expressed by the dashed lines and the two hyperbolas expressed by the dash-dot lines. The positioning unit 126 can identify the position of the smartphone 200 at the intersection S3. The reason why the position of the smartphone 200 can be identified at the intersection S3 is the fact that the intersection S3 is defined under (i) a condition in which the intersection S3 is on any one of two hyperbolas (dashed lines) defined using a differential distance for a combination of the wireless communication units 110A and 110B and (ii) a condition in which the intersection S3 is on any one of two hyperbolas (dashed lines) defined using a differential distance for a combination of the wireless communication units 110A and 110C.

### Modification to the Third Positioning Method

The third positioning method is described using a case where the synchronization controller 123 corrects one or more among the clocks of the wireless communication units 110A and 110B such that the clocks are synchronized, and also, the synchronization controller 123 corrects one or more among the clocks of the wireless communication units 110A and 110C such that the clocks are synchronized. In this arrangement, the distance calculator 122 calculates the distance L between the wireless communication units 110A and 110B, and also calculates the distance L between the wireless communication units 110A and 110C.

However, in a modification to the third positioning method, the synchronization controller 123 may correct one or more among the clocks of the wireless communication units 110A and 110B such that the clocks are synchronized, and also, the synchronization controller 123 may correct one or more among the clocks of the wireless communication units 110B and 110C such that the clocks are synchronized. With this approach, one or more among clocks of the wireless communication units 110A, 110B, and 110C can be corrected such that the clocks are synchronized. In this case, when the distance calculator 122 may calculate a given distance L between the wireless communication units 110A and 110B, and may also calculate a distance L between the wireless communication units 110B and 110C.

After one or more among the clocks of the wireless communication units 110A, 110B, and 110C are corrected, the differential-distance determining unit 124 may determine a differential distance between a distance from the smartphone 200 to the wireless communication unit 110B and a distance from the smartphone 200 and the wireless communication unit 110C, based on (i) the phase α5 of the packet signal that is transmitted at the frequency f1 from the smartphone 200 and is received by the wireless communication unit 110C, (ii) the phase α6 of the packet signal that is transmitted at the frequency f2 from the smartphone 200 and is received by the wireless communication unit 110C, and (iii) phases α3 and α4.

The positioning unit 126 may determine, as the position of the smartphone 200 with respect to the wireless communication units 110A, 110B, and 110C, a point that is obtained under (i) a condition in which the point is on any one among two hyperbolas defined using a differential distance for a combination of wireless communication units 110A and 110B and (ii) a condition in which the point is on any one among two hyperbolas defined using a differential distance for a combination of wireless communication units 110B and 110C.

### Fourth Positioning Method

In a fourth positioning method, time points t1 and t2, and an absolute value |L1−L2| of the differential distance between distances L1 and L2 are determined under the condition in which the synchronization controller 123 corrects one or more among clocks of the wireless communication units 110A and 110B and thus the clocks are synchronized. The time points t1 and t2 are time points at which the wireless communication units 110A and 110B receive respective packet signals. A time point t1 is an example of a first time point, and the time point t2 is an example of a second time point. The differential-distance determining unit 124 determines the absolute value |L1−L2| of the differential distance by using Equation (6), as described in the first positioning method.

In the fourth positioning method, by use of the time points t1 and t2 and the speed of light c, the main controller 121 determines a differential distance ΔL between the distance from the smartphone 200 to the wireless communication unit 110A and the distance from the smartphone 200 to the wireless communication unit 110B. The differential distance ΔL can be expressed by Equation (8) below. A difference between the time points t1 and t2, (t1−t2), is an example of a difference between the first time point and the second time point.

$$\begin{matrix}[ Math . 8 ] & \\ Δ L = \frac{t 1 - t 2}{c} & ( 8 )\end{matrix}$$

The differential-distance determining unit 124 determines the absolute value |L1−L2| of a given differential distance by using phases α1 and α2. On the other hand, the main controller 121 determines a given differential distance ΔL by using the time points t1 and t2 and the speed of light c. With this approach, the given differential distance ΔL is determined more accurately than the absolute value |L1−L2| of the differential distance. Thus, the given differential distance ΔL can be used as an evaluation reference for the absolute value |L1−L2| indicative of the given differential distance.

With this arrangement, the main controller 121 evaluates the absolute value |L1−L2| of the differential distance by using the differential distance ΔL. In the evaluation, a quality factor Q indicating an accuracy (quality) of a differential distance, L1−L2, is used. With use of an absolute value |ΔL| of the differential distance, the quality factor Q can be expressed by Equation (9) below.

$$\begin{matrix}[ Math . 9 ] & \\ Q = \frac{\vert L 1 - L 2 \vert - \vert Δ L \vert}{\vert L 1 - L 2 \vert} & ( 9 )\end{matrix}$$

The main controller 121 evaluates the quality of the differential distance, L1−L2, based on Equation (9) and a difference between time points t1 and t2 and a differential distance, L1−L2, as determined by the differential-distance determining unit 124. In the fourth positioning method, the quality factor Q for evaluating a quality of the absolute value |L1−L2| of the differential distance, as determined by the differential-distance determining unit 124, can be determined. In calculating the position of the smartphone 200 by each of the first positioning method, the second positioning method, and the third positioning method, the quality factor Q can be used to evaluate the differential distance, L1−L2, determined by the differential-distance determining unit 124.

As described above, in the positioning device 100, the synchronization controller 123 corrects, based on a difference (L−L0) between the distance L calculated by the distance calculator 122 and the predetermined distance L0, one or more among phases of clocks of wireless communication units 110 such that the clocks of the wireless communication units 110 are synchronized. The phase of a given clock can be corrected with a 1 ns (nanosecond)-level precision.

With this arrangement, it is possible to provide the positioning device 100 capable of correcting one or more phases of clocks of wireless communication units 110 with high accuracy.

In addition, the distance calculator 122 can reliably and easily calculate a given distance L between wireless communication units 110, by using Equations (1) to (5). Also, the synchronization controller 123 corrects one or more among phases of clocks of the wireless communication units 110 based on the difference (L−L0) between the given distance L calculated by the distance calculator 122 and the predetermined distance L0. Therefore, one or more phases of the clocks can be reliably and easily corrected with a 1 ns (nanosecond)-level precision.

In a first manner, the positioning unit 126 can narrow the position of the smartphone 200 to points on two hyperbolas (hyperbolas for the wireless communication units 110A and 110B) that are defined based on a given differential distance (|L1−L2|) that is determined by the differential-distance determining unit 124, and as a result, an approximate position of the smartphone 200 can be determined. The two hyperbolas are obtained by performing positioning with a time of arrival (TOA) that is used for the wireless communication units 110A and 110B. With this approach, it is possible to provide the positioning device 100 that corrects one or more among phases of clocks of wireless communication units 110, with high accuracy, thereby determining an approximate position of the smartphone 200 with the TOA.

In a second manner, the positioning unit 126 can identify the position of the smartphone 200 at an intersection of (i) any one of two hyperbolas (hyperbolas for the wireless communication units 110A and 110B), defined using a given differential distance determined by the differential-distance determining unit 124 and (ii) any one of arrival directions, of packet signals in operations between the wireless communication units 110A and 110B, as determined by the direction determining unit 125. The two hyperbolas are determined by performing positioning with the TOA that is performed in operations between the wireless communication units 110A and 110B, and the arrival directions are determined by detecting a given angle with an angle of arrival (AOA) that is performed in operations between the wireless communication units 110A and 110B. With this approach, it is possible to provide the positioning device 100 that can correct one or more among phases of clocks of the wireless communication units 110, with high accuracy, and that can identify the position of the smartphone 200 by using a combination of the TOA and the AOA.

In a third manner, an intersection of (i) any one among two hyperbolas that are defined based on a given differential distance between the distance from the smartphone 200 and to wireless communication unit 110A and the distance from the smartphone 200 to the wireless communication unit 110B, and (ii) any one among two hyperbolas that are defined based on a given differential distance between the distance from the smartphone 200 to the wireless communication unit 110A and the distance from the smartphone 200 to the wireless communication unit 110C, can be identified as the position of the smartphone 200. Four hyperbolas are defined by (iii) performing positioning with the TOA that is performed for wireless communication units 110A and 110B, and by (iv) performing positioning with the TOA that is performed for wireless communication units 110A and 110C. With this approach, it is possible to provide the positioning device 100 that corrects one or more among phases of clocks of wireless communication units 110, with high accuracy, and that can identify the position of the smartphone 200 by performing positioning with the TOA.

In addition, it is possible to identify, as the position of the smartphone 200, an intersection between (i) any one of two hyperbolas that are defined using differential distances between a distance from the smartphone 200 to any one communication unit among the wireless communication units 110A and 110B and a distance from the smartphone 200 to the other communication unit, and (ii) any one of two hyperbolas that are defined using differential distances between a distance from the smartphone 200 to any one communication unit among the wireless communication units 110B and 110C and a distance from the smartphone 200 to the other communication unit.

Although the positioning device and the method for correcting a clock according to the embodiment of the present disclosure have been described above, the present disclosure is not limited to specifically disclosed embodiment (s), and various variations and changes can be made without departing from the scope of the claims.

A positioning device and a method for correcting a clock that are capable of correcting one or more phases of clocks of wireless communication devices, with high accuracy, can be provided.

What is claimed is:

1. A positioning device for determining a position of a mobile communication device, the positioning device comprising:
a first wireless communication device;
a second wireless communication device disposed at a first distance from the first wireless communication device;
a processor configured to
determine a second distance between the first wireless communication device and the second wireless communication device based on (i) a first phase of a first signal that is transmitted at a first frequency from the first wireless communication device and is received by the second wireless communication device, (ii) a second phase of a second signal that is transmitted at a second frequency from the first wireless communication device and is received by the second wireless communication device, and (iii) the first distance, and
correct, based on a first differential distance between the first distance and the second distance, a clock of at least one of the first wireless communication device or the second wireless communication device, such that clocks of the first wireless communication device and the second wireless communication device are synchronized.

2. The positioning device according to claim 1, wherein the processor is configured to determine the second distance according to the following equations:
$$L = ( n + P 1 ) \times λ 1 \qquad ( 1 )$$
$$L = ( n + P 2 ) \times λ 2 \qquad ( 2 )$$
$$n = L / λ 1 - P 1 \qquad ( 3 )$$
$$n = L / λ 2 - P 2 \qquad ( 4 )$$
$$L = c \times ( P 1 - P 2 ) / ( f 1 - f 2 ) , \qquad ( 5 )$$
wherein:
L0 is the first distance,
L is the second distance,
n indicates each of a wavenumber of the first signal having the first frequency in a communication between the first wireless communication unit and the second wireless communication unit and a wavenumber of the second signal having the second frequency in the communication between the first wireless communication unit and the second wireless communication unit,
P1 is the first phase,
P2 is the second phase, and
c is a speed of light, and
wherein Equation (5) is obtained from Equations (3) and (4).

3. The positioning device according to claim 1, wherein after correcting the clock, the processor is configured to
determine a second differential distance between a third distance from the mobile communication device to the first communication device and a fourth distance from the mobile communication device to the second communication device, based on (i) a third phase of a third signal that is transmitted at the first frequency from the mobile communication device and is received by the first communication device, (ii) a fourth phase of a fourth signal that is transmitted at the second frequency from the mobile communication device and is received by the first communication device, (iii) a fifth phase of a fifth signal that is transmitted at the first frequency from the mobile communication device and is received by the second communication device, (iv) a sixth phase of a sixth signal that is transmitted at the second frequency from the mobile communication device and is received by the second communication device, and
determine the position of the mobile communication device with respect to the first communication device and the second communication device, based on the second differential distance.

4. The positioning device according to claim 3, wherein each of the first wireless communication device and the second wireless communication device includes multiple antennas,
wherein the processor is configured to
determine a first arrival direction in which at least one signal from the mobile communication device arrives at the first wireless communication device, based on a first phase difference of the at least one signal that is received by the multiple antennas of the first wireless communication device, or
determine a second arrival direction in which at least one signal from the mobile communication device arrives at the second wireless communication device, based on a second phase difference of the at least one signal that is received by the multiple antennas of the second wireless communication device, and
wherein the processor is configured to determine the position of the mobile communication device with respect to the first communication device and the second communication device, based on the first differential distance and either the first arrival direction or the second arrival direction.

5. The positioning device according to claim 4, wherein the at least one signal received by the multiple antennas of the first wireless communication device includes at least one of the third signal or the fourth signal, and
wherein the at least one signal received by the multiple antennas of the second wireless communication device includes at least one of the fifth signal or the sixth signal.

6. The positioning device according to claim 3, further comprising:
a third wireless communication device disposed at a position at a fifth distance from the first wireless communication device,
wherein the processor is configured to
determine a sixth distance between the first wireless communication device and the third wireless communication device based on (i) a seventh phase of a seventh signal that is transmitted at the first frequency from the first wireless communication device and is received by the third wireless communication device, (ii) an eighth phase of an eighth signal that is transmitted at the second frequency from the first wireless communication device and is received by the third wireless communication device, and (iii) the fifth distance,
correct, based on a third differential distance between the fifth distance and the sixth distance, a clock of at least one of the first wireless communication device or the third wireless communication device, such that clocks of the first wireless communication device and the third wireless communication device are synchronized,
determine, after correcting the clock of the at least one of the first wireless communication device or the third wireless communication device, a fourth differential distance between the third distance from the mobile communication device to the first communication device and a fifth distance from the mobile communication device to the third communication device, based on (i) a ninth phase of a ninth signal that is transmitted at the first frequency from the mobile communication device and is received by the third communication device, (ii) a tenth phase of a tenth signal that is transmitted at the second frequency from the mobile communication device and is received by the third communication device, (iii) the third phase, and (iv) the fourth phase, and
determine the position of the mobile communication device with respect to the first communication device, the second communication device, and the third communication device, based on the third differential distance and the fourth differential distance.

7. The positioning device according to claim 3, further comprising:
a third wireless communication device disposed at a position at a fifth distance from the second wireless communication device,
wherein the processor is configured to
determine a sixth distance between the second wireless communication device and the third wireless communication device based on (i) a seventh phase of a fifth signal that is transmitted at the first frequency from the second wireless communication device and is received by the third wireless communication device, (ii) an eighth phase of a sixth signal that is transmitted at the second frequency from the second wireless communication device and is received by the third wireless communication device, and (iii) the fifth distance,
correct, based on a third differential distance between the fifth distance and the sixth distance, a clock of at least one of the second wireless communication device or the third wireless communication device, such that clocks of the second wireless communication device and the third wireless communication device are synchronized,
determine, after correcting the clock of the at least one of the second wireless communication device or the third wireless communication device, a fourth differential distance between the fourth distance from the mobile communication device to the second communication device and a fifth distance from the mobile communication device to the third communication device, based on (i) a ninth phase of a ninth signal that is transmitted at the first frequency from the mobile communication device and is received by the third communication device, (ii) a tenth phase of a tenth signal that is transmitted at the second frequency from the mobile communication device and is received by the third communication device, (iii) the fifth phase, and (iv) the sixth phase, and
determine the position of the mobile communication device with respect to the first communication device, the second communication device, and the third communication device, based on the third differential distance and the fourth differential distance.

8. The positioning device according to claim 3, wherein the processor is configured to evaluate a quality of the second differential distance based on (i) a difference between a first timing and a second timing at which the first wireless communication device and the second wireless communication device receive any respective signals, among the third signal, the fourth signal, the fifth signal, and the sixth signal and (ii) the second differential distance.

9. A method for correcting a clock of a positioning device that determines a position of a mobile communication unit, the positioning device including
a first wireless communication device, and
a second wireless communication device disposed at a first distance from the first wireless communication device, and the method comprising:
determining a second distance between the first wireless communication device and the second wireless communication device based on (i) a first phase of a first signal that is transmitted at a first frequency from the first wireless communication device and is received by the second wireless communication device, (ii) a second phase of a second signal that is transmitted at a second frequency from the first wireless communication device and is received by the second wireless communication device, and (iii) the first distance; and
correcting, based on a first differential distance between the first distance and the second distance, a clock of at least one of the first wireless communication device or the second wireless communication device, such that clocks of the first wireless communication device and the second wireless communication device are synchronized.
